(19) United States
(12) Patent Application Publication
(10) Pub. No.: US 2008/0104961 A1
(43) Pub. Date: May 8, 2008

(54) METHOD AND APPARATUS FOR ENHANCED MIXING IN PREMIXING DEVICES

(76) Inventor: Ronald Scott Bunker, Niskayuna, NY (US)

Correspondence Address: GENERAL ELECTRIC CO.;GLOBAL PATENT OPERATION, 187 Danbury Road, Suite 204, Wilton, CT, 06897-4122, US

(21) Appl. No.: 11/557,735

(22) Filed: Nov. 8, 2006

(51) Int. Cl. F02C 1/00

(52) U.S. Cl. 60/737; 60/752

(57) ABSTRACT

A premixing device includes an air inlet to introduce compressed air into a mixing chamber and a fuel plenum to provide fuel to the mixing chamber via at least one slot and over a pre-determined wall profile to form a fuel boundary layer, the mixing chamber including a surface treatment disposed on at least a portion of an inside wall thereof to aerodynamically enhance the mixing of fuel from the boundary layer with the compressed air, without causing a boundary layer flow separation and flame holding in the mixing chamber. Low-emission combustors, gas turbine combustors, methods for premixing a fuel and an oxidizer in a combustion system, a gas turbine, and a gas-to-liquid system using the premixing device are also disclosed.

### BACKGROUND OF THE INVENTION

1. Field of the Invention

Embodiments of the present invention relate in general to combustors and, more particularly, to premixing devices with surface treatments for enhanced mixing of fuel and oxidizer in low-emission combustion processes.

2. Description of the Related Art

Historically, the extraction of energy from fuels has been carried out in combustors with diffusion-controlled (also referred to as non-premixed) combustion where the reactants are initially separated and reaction occurs only at the interface between the fuel and oxidizer, where mixing and reaction both take place. Examples of such devices include, but are not limited to, aircraft gas turbine engines and aero-derivative gas turbines for applications in power generation, marine propulsion, gas compression, cogeneration, and offshore platform power to name a few. In designing such combustors, engineers are not only challenged with persistent demands to maintain or reduce the overall size of the combustors, to increase the maximum operating temperature, and to increase specific energy release rates, but also with an ever increasing need to reduce the formation of regulated pollutants and their emission into the environment. Examples of the main pollutants of interest include oxides of nitrogen (NOₓ), carbon monoxide (CO), unburned and partially burned hydrocarbons, and greenhouse gases, such as carbon dioxide (CO₂). Because of the difficulty in controlling local composition variations in the flow due to the reliance on fluid mechanical mixing while combustion is taking place, peak temperatures associated with localized stoichiometric burning, residence time in regions with elevated temperatures, and oxygen availability, diffusion-controlled combustors offer a limited capability to meet current and future emission requirements while maintaining the desired levels of increased performance.

Recently, lean premixed combustors have been used to further reduce the levels of emission of undesirable pollutants. In these combustors, proper amounts of fuel and oxidizer are well mixed prior to the occurrence of any significant chemical reaction, thus facilitating the control of the above-listed difficulties of diffusion-controlled combustors. However, because a combustible mixture of fuel and oxidizer is formed before the desired location of flame stabilization, premixed combustor designers are continuously challenged with the control of any flow separation and/or flame holding in the regions where mixing takes place so as to minimize and/or eliminate undesirable combustion instabilities. Current design challenges also include the control of the overall length of the region where mixing of fuel and oxidizer takes place and the minimization of pressure drop associated with the premixing process. These challenges are further complicated with the need for combustors capable of operating properly with a wide range of fuels, including, but not limited to, natural gas, hydrogen, and synthesis fuel gases (also known as syngas), which are gases rich in carbon monoxide and hydrogen obtained from gasification processes of coal or other materials.

Conventional premixed burners incorporate fuel jets positioned between vanes of a swirler or on the surface of the vane airfoils. However, this cross-flow injection of fuel generates localized regions of high and low concentrations of fuel/air mixtures within the combustor, thereby resulting in substantially higher emissions. Further, such cross-flow injection results in fluctuations and modulations in the combustion processes due to the fluctuations in the fuel pressure and the pressure oscillations in the combustor that may result in destructive dynamics within the combustion process. Recently, premixing devices using Coanda surfaces have been proposed as a way to minimize the negative effects of premixed combustors that depend primarily on cross-flow fuel injection to achieve a desired level of premixing and overall performance. In these devices, fuel injected along a Coanda surface adheres to the surface as the mainstream airflow is accelerated, preventing liftoff and separation of the fuel jets as well as undesirable pressure fluctuations that may cause combustion instability. However, since the fuel jet is maintained next to the diverging wall of the premixing device, the efficient mixing of the fuel with the oxidizer is somewhat delayed, thus resulting in premixing devices that are unnecessarily long in order to assure proper mixing of fuel and oxidizer. If the length of the premixing device is constrained by an overall engine length requirement, for example, the fuel concentration profile delivered to the flame zone may contain unwanted spatial variations, thus minimizing the full effect of premixing on the pollutant formation process as well as possibly affecting the overall flame stability in the combustion zone.

Although surface treatments have been used to enhance heat transfer in various applications (see, for example, U.S. Pat. Nos. 6,644,921 and 6,504,274, disclosing the use of concavities to maintain the operating temperatures at acceptable levels in a turbine portion or an electric generator, respectively; U.S. Pat. Nos. 6,468,669 and 6,598,781, disclosing the use metal components used in turbine engines having protuberances in order to increase the heat transfer characteristic on various surfaces operating at high temperatures; and U.S. Pat. No. 7,104,067, disclosing a plurality of axially spaced circumferential grooves on an outside surface of a combustor liner to provide enhanced levels of cooling at reduced pressure losses), the use of treatments on Coanda surfaces of premixed combustors in order to enhance the mixing of fuel and oxidizer is unknown to this inventor.

Therefore, a need exists for a premixing device for use in lean-premixed combustors having enhanced capabilities of mixing fuel and oxidizer while maintaining control of flow separation and flame holding in the mixing region of the combustor. The increased mixing performance will permit the development of premixing devices having a reduced length without substantially affecting the overall pressure drop in the device; premixed combustors incorporating such premixers being particularly suitable for use with fuels having a wide range of composition, heating values and specific volumes.

### BRIEF SUMMARY OF THE INVENTION

One or more of the above-summarized needs and others known in the art are addressed by premixing devices that include an air inlet, a fuel plenum in flow communication with the air inlet having at least one fuel inlet slot over a wall profile adjacent the fuel plenum, and a mixing chamber disposed downstream of the air inlet and the at least one fuel inlet slot to mix compressed air from the air inlet with fuel along a boundary layer of fuel mixed with air formed by the wall profile, the mixing chamber including a surface treatment disposed on at least a portion of an inside wall thereof, the surface treatment being configured to aerodynamically enhance the mixing of fuel from the boundary layer with the compressed air without causing a boundary layer flow separation and flame holding in the mixing chamber. Embodiments of the invention disclosed also include low-emission combustors and gas turbine combustors having the above-summarized premixing devices.

In another aspect of the disclosed inventions, gas turbines are disclosed that include a compressor, a combustor to burn a premixed mixture of fuel and air in flow communication with the compressor, and a turbine located downstream of the combustor to expand the high-temperature gas stream exiting the combustor. The combustors of such gas turbines include a premixing device having an air inlet, a fuel plenum in flow communication with the air inlet having at least one fuel inlet slot over a wall profile adjacent the fuel plenum, and a mixing chamber disposed downstream of the air inlet and the at least one fuel inlet slot to mix compressed air from the air inlet with fuel along a fuel boundary layer formed by the wall profile, the mixing chamber including a surface treatment disposed on at least a portion of an inside wall thereof, the surface treatment being configured to aerodynamically enhance the mixing of fuel from the boundary layer with the compressed air without causing a boundary layer flow separation and flame holding in the mixing chamber.

In another aspect of the disclosed inventions, gas-to-liquid systems are disclosed that include an air separation unit configured to separate oxygen from air, a gas processing unit for preparing natural gas, a combustor for reacting oxygen with the natural gas at an elevated temperature and pressure to produce a synthesis gas enriched with carbon monoxide and hydrogen gas, and a turbo-expander in flow communication with the combustor for extracting work from and for quenching the synthesis gas. The combustor of such gas-to-liquid systems including premixing devices disposed upstream of the combustor to facilitate the premixing of oxygen and the natural gas prior to reaction in the combustor, the premixing device including an air inlet, a fuel plenum in flow communication with the air inlet having at least one fuel inlet slot over a wall profile adjacent the fuel plenum, and a mixing chamber disposed downstream of the air inlet and the at least one fuel inlet slot to mix compressed air from the air inlet with fuel along a fuel boundary layer formed by the wall profile, the mixing chamber including a surface treatment disposed on at least a portion of an inside wall thereof, the surface treatment being configured to aerodynamically enhance the mixing of fuel from the boundary layer with the compressed air without causing a boundary layer flow separation and flame holding in the mixing chamber.

Methods for premixing a fuel and an oxidizer in a combustion system are also within the scope of the embodiments of the invention disclosed, such methods including the steps of drawing an oxidizer inside a premixing device, injecting fuel into the premixing device, deflecting the injected fuel towards a wall profile within the premixing device so as to form a fuel boundary layer along an inside wall of the premixing device, and premixing the fuel and oxidizer to form a fuel-air mixture without causing a flow separation and a flame holding in the mixing chamber, the premixing step including enhancing an entrainment of the oxidizer into the fuel boundary layer via turbulence generated in the fuel boundary layer by a surface treatment disposed on at least a portion of an inside wall of the premixing device.

The above brief description sets forth features of the present invention in order that the detailed description thereof that follows may be better understood, and in order that the present contributions to the art may be better appreciated. There are, of course, other features of the invention that will be described hereinafter and which will be for the subject matter of the appended claims.

In this respect, before explaining several preferred embodiments of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a diagrammatical illustration of a gas turbine having a combustor with a premixing device in accordance with aspects of the present technique;

FIG. 2 is a diagrammatical illustration of an exemplary configuration of a low-emission combustor employed in the gas turbine of FIG. 1 in accordance with aspects of the present technique;

FIG. 3 is a diagrammatical illustration of another exemplary configuration of a low-emission combustor employed in the gas turbine of FIG. 1 in accordance with aspects of the present technique;

FIG. 4 is a cross-sectional view of an exemplary configuration of a premixing device employed in the combustor of FIG. 1 with an embodiment of a surface treatment disposed on an inside wall of the premixing device in accordance with aspects of the present technique;

FIG. 5 illustrates a schematic of the flow inside one element of the surface treatment of FIG. 4;

FIG. 6 illustrates a geometric variation of the surface treatment of FIG. 4;

FIG. 7 illustrates another geometric variation of the surface treatment of FIG. 4;

FIG. 8 illustrates another embodiment of a surface treatment disposed on an inside wall of the premixing device employed in the combustor of FIG. 1 in accordance with aspects of the present technique;

FIG. 9 illustrates yet another embodiment of a surface treatment disposed on an inside wall of the premixing device employed in the combustor of FIG. 1 in accordance with aspects of the present technique;

FIG. 10 shows a photograph of yet another embodiment of a surface treatment disposed on an inside wall of the premixing device employed in the combustor of FIG. 1 in accordance with aspects of the present technique; and

FIG. 11 shows a photograph of yet another embodiment of a surface treatment disposed on an inside wall of the premixing device employed in the combustor of FIG. 1 in accordance with aspects of the present technique.

### DETAILED DESCRIPTION OF THE PREFERRED EMBODIMENTS

Referring now to the drawings, wherein like reference numerals designate identical or corresponding parts throughout the different views, several embodiments of the premixing devices being disclosed will be described. In the explanations that follow, exemplary embodiments of the disclosed premixing devices used in a gas turbine will be used. Nevertheless, it will be readily apparent to those having ordinary skill in the applicable arts that the same premixing devices may be used in other applications in which combustion is primarily controlled by premixing of fuel and oxidizer.

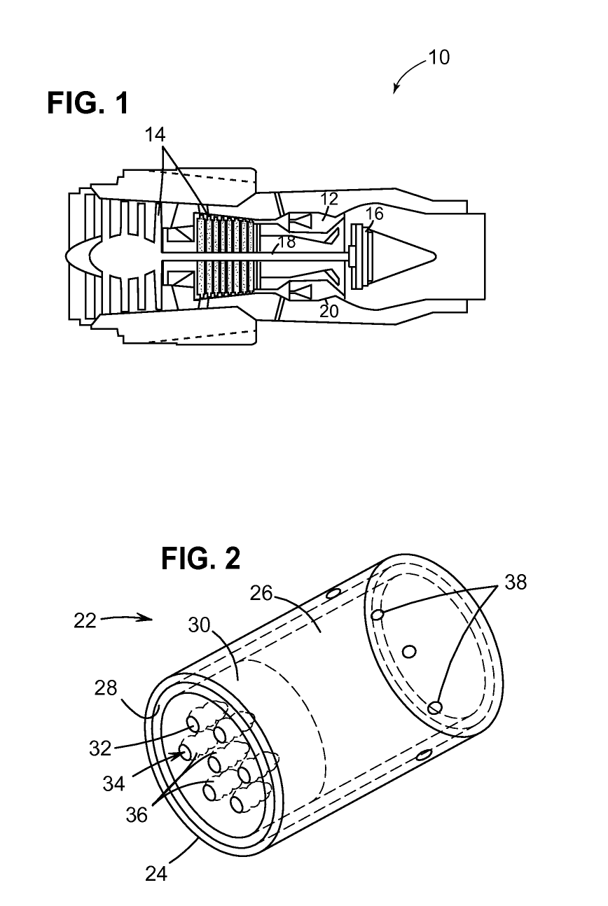

FIG. 1 illustrates a gas turbine 10 having a compressor 14, which, in operation, supplies high-pressure air to a low-emission combustor 12. Subsequent to combustion of fuel injected into the combustor 12 with air (or another oxidizer), high-temperature combustion gases at high pressure exit the combustor 12 and expands through a turbine 16, which drives the compressor 14 via a shaft 18. As understood by those of ordinary skill in the art, references herein to air or airflow also refers to any other oxidizer, including, but not limited to, pure oxygen or a vitiated airflow having a volumetric oxygen content of less than 21% (e.g., 10%). In one embodiment, the combustor 12 includes a can combustor. In an alternate embodiment, the combustor 12 includes a can-annular combustor or a purely annular combustor. Depending on the application, the combustion gases may be further expanded in a nozzle (not shown) in order to generate thrust or gas turbine 10 may have an additional turbine (not shown) to extract additional energy from the combustion gases to drive an external load.

In the illustrated embodiment, the combustor 12 includes a combustor housing 20 defining a combustion area. In addition, the combustor 12 includes a premixing device for mixing compressed air and fuel prior to combustion in the combustion area. In particular, the premixing device employs a Coanda effect to enhance the efficiency of the mixing process. As used herein, the term “Coanda effect” refers to the tendency of a stream of fluid to attach itself to a nearby surface and to remain attached even when the surface curves away from the original direction of fluid motion.

FIG. 2 illustrates an exemplary configuration of a low-emission combustor 22 employed in the gas turbine 10 of FIG. 1. In the illustrated embodiment, the combustor 22 includes a can combustor. The combustor 22 includes a combustor casing 24 and a combustor liner 26 disposed within the combustor casing 24. The combustor 22 also includes a dome plate 28 and a heat shield 30 configured to reduce the temperature of the combustor walls. Further, the combustor 22 includes a plurality of premixing devices 32 for premixing the oxidizer and fuel prior to combustion. In one embodiment, the plurality of premixing devices 32 may be arranged to achieve staged fuel introduction within the combustor 22 for applications employing fuels such as hydrogen. In operation, the premixing device 32 receives an airflow 34, which is mixed with the fuel introduced into the premixing device 32 from a fuel plenum. Subsequently, the air-fuel mixture is burned in flames 36 inside the combustor 22. Dilution or cooling holes 38 may also be provided in the casing 24, as illustrated.

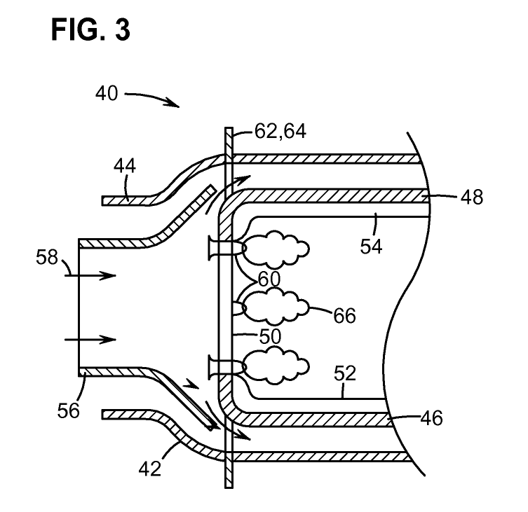

FIG. 3 illustrates another exemplary configuration of another low-emission combustor 40 employed in the gas turbine 10 of FIG. 1. In the illustrated embodiment, the combustor 40 includes an annular combustor. As illustrated, an inner casing 42 and an outer casing 44 define the combustion area within the combustor 40. In addition, the combustor 40 typically includes inner and outer combustor liners 46 and 48 and a dome plate 50. Further, the combustor 40 includes inner and outer heat shields 52 and 54 disposed adjacent to the inner and outer combustor liners 46 and 48 and a diffuser section 56 for directing an airflow 58 inside the combustion area. The combustor 40 also includes a plurality of premixing devices 60 disposed upstream of the combustion area. In operation, a respective premixing device 60 receives fuel from a fuel plenum via fuel lines 62 and 64, which fuel is directed to flow over a pre-determined wall profile inside the premixing device 60 for enhancing the mixing efficiency of the premixing device 60 by entraining air using the Coanda effect. Further, the fuel from the fuel lines 62 and 64 is mixed with the incoming airflow 58 and a fuel-air mixture for combustion is delivered to flame 66. In this embodiment, the introduction of fuel alters the air splits within the combustor 40. Particularly, the dilution air is substantially reduced and the combustion air split increases within the combustor 40 due to change in pressure effected by the Coanda effect.

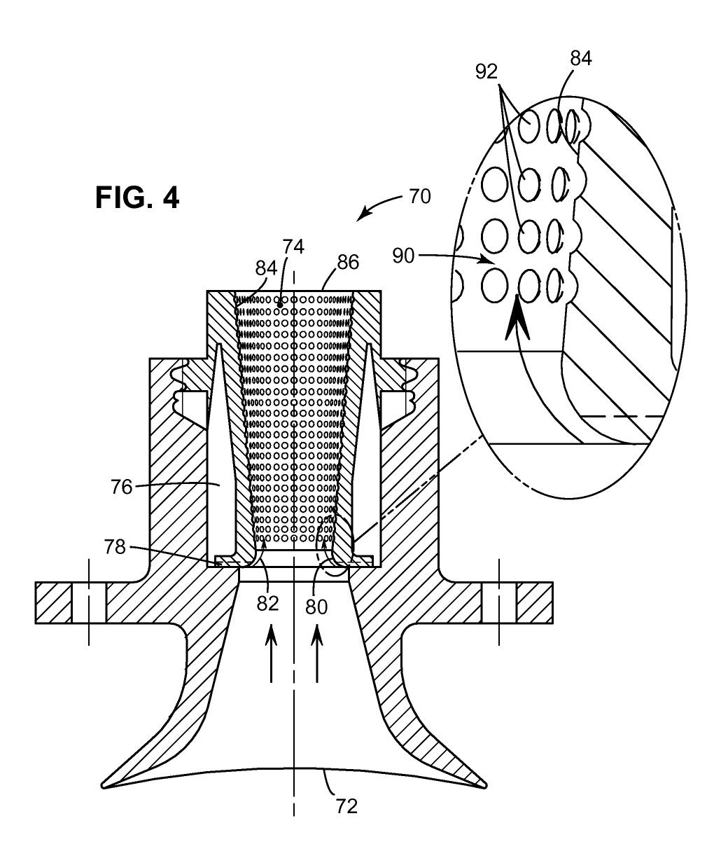

FIG. 4 is a cross-sectional view of an exemplary configuration of a premixing device 70 employed in the above-described combustors. In the embodiment illustrated in FIG. 4, the premixing device 70 includes an air inlet 72 configured to introduce compressed air into a mixing chamber 74. Further, the premixing device 70 includes a fuel plenum 76 from which fuel is provided to the mixing chamber 74 via a circumferential slot 78. As understood by those of ordinary skill in the applicable arts, the slot 78 may be continuously or discretely disposed around the circumference of the premixing device 70. The fuel introduced via the circumferential slot 78 is deflected over a pre-determined wall profile 80, creating a fuel flow 82. In this exemplary embodiment, the premixing device 70 has an annular configuration and the fuel is introduced radially in and across the pre-determined wall profile 80. The geometry and dimensions of the pre-determined wall profile 80 may be selected/optimized based upon a desired premixing efficiency and the operational conditions including factors such as, but not limited to, fuel pressure, fuel temperature, temperature of incoming air, and fuel injection velocity. Examples of fuel include natural gas, high hydrogen gas, pure hydrogen, biogas, carbon monoxide and syngas. However, a variety of other fuels may be employed. In the illustrated embodiment, the pre-determined wall profile 80 causes the introduced fuel to further attach to the wall profile 80 based upon the Coanda effect, forming a boundary layer. This boundary layer formed adjacent the pre-determined wall profile 80 effects air entrainment, thereby enhancing the mixing efficiency within the mixing chamber 74 of the premixing device 70. U.S. patent application with Ser. No. 11/273,212, commonly assigned to the assignee of this application, further discusses a premixing device having a Coanda surface. The contents of that patent application are incorporated herein by reference in its entirety.

In the illustrated embodiment, the incoming air is introduced in the premixing device 70 via the air inlet 72. In certain embodiments, the flow of air may be introduced through a plurality of air inlets that are disposed upstream or downstream of the circumferential slot 78 to facilitate mixing of the air and fuel within the mixing chamber 74. Similarly, the fuel may be injected at multiple locations through a plurality of slots along the length of the premixing device 70. In another embodiment, the premixing device 70 may include a swirler (not shown) disposed upstream of the device 70 for providing a swirl movement in the air introduced in the mixing chamber 74. In another embodiment, a swirler (not shown) is disposed at the fuel inlet gap for introducing swirling movement to the fuel flow across the pre-determined wall profile 80. In yet another embodiment the air swirler may be placed at the same axial level and co-axial with the premixing device 70, at the outlet plane from the premixing device 70.

Moreover, the premixing device 70 also includes a diffuser 84 having a straight or divergent profile for directing the fuel-air mixture formed in the mixing chamber 74 to the combustion section via an outlet 86. In one embodiment, the angle for the diffuser 84 is in a range of about +/−0 degrees to about 25 degrees. The degree of premixing of the premixing device 70 is controlled by a plurality of factors such as, but not limited to, the fuel type, geometry of the pre-determined wall profile 80, degree of pre-swirl of the air, size of the circumferential slot 78, fuel pressure, fuel temperature, temperature of incoming air, length and angle of the diffuser 84 and fuel injection velocity.

In operation, the pre-determined wall profile 80 facilitates the formation of a boundary layer along the diffuser 84 while a portion of the airflow from the air inlet 72 is entrained by the boundary layer to form a shear layer for promoting the mixing of the incoming air and fuel. In the illustrated embodiment, the fuel is supplied at a pressure relatively higher than the pressure of the incoming oxidizer. In one embodiment, the fuel pressure is about 1% to about 25% greater than the pressure of the incoming air at the air inlet 72.

The above-described boundary layer is formed by a Coanda effect. In the illustrated embodiment, the fuel flow 82 attaches to the wall profile 80 and remains attached even when the surface of the wall profile 80 curves away from the initial fuel flow direction. More specifically, as the fuel flow accelerates around the wall profile 80 there is a pressure difference across the flow, which deflects the fuel flow 82 closer to the surface of the wall profile 80. As will be appreciated by one of ordinary skill in the art, as the fuel flow 82 moves across the wall profile 80, a certain amount of skin friction occurs between the fuel flow 82 and the wall profile 80. This resistance to the flow deflects the fuel flow 82 towards the wall profile 80, thereby causing it to remain close to the wall profile 80. Further, the fuel boundary layer formed by this mechanism entrains incoming airflow to form the shear layer to promote mixing of the airflow and fuel. As such, although reference here is made of a fuel boundary layer, due to the enhanced entrainment of air in the boundary layer created by the Coanda surface, the resulting boundary layer along the wall does not include only fuel, but a mixture of fuel and air, as explained.

Several surface geometries or treatments disposed on the inside surface of the diffuser 84 serve to improve and hasten turbulent mixing of the fuel and air without causing flow separation on the surface and subsequent premature combustion in unwanted regions. As used herein, the expression “surface geometry” or “surface treatment” means physical modifications of a surface of the premixing device 70 in order to aerodynamically generate vortical structures and wall turbulence to increase the mixing of air and fuel without inducing an additional substantial pressure drop in the system or flow separation. These surface treatments may also be disposed on the surface of the wall profile 80 and/or on any portions of inside walls of the fuel slot. These features improve the mixing process by the generation of surface vortical structures, or wall turbulence, rather than shear layers and bluff body effects. With improved mixing of fuel and oxidizer, the overall length of the premixing device is reduced while eliminating or substantially reducing the possibility of flow separation and consequent flame holding, leading to premature combustion in the mixing chamber 74.

FIG. 4 also illustrates a first embodiment 90 of the surface treatments. As shown, this first embodiment includes an orderly patterned array of shallow concavities 92 disposed along the interior surface of the diffuser 84. In the illustrated embodiment, the concavities 92 are formed on the interior surface of the diffuser 84 in an array pattern such that surface fluid vortical structures are obtained. The surface pattern of the concavity 92 serves to enhance mixing of fuel and oxidizer, but with significantly less pressure loss due to friction as compared to conventional gadgets used to induce mixing, such as machined turbulators. The localized generation of surface fluid vortical structures causes an enhanced entrainment of the air flowing along the central portion of the diffuser 84 toward regions next to the surface, thereby expediting the mixing process of fuel and oxidizer.

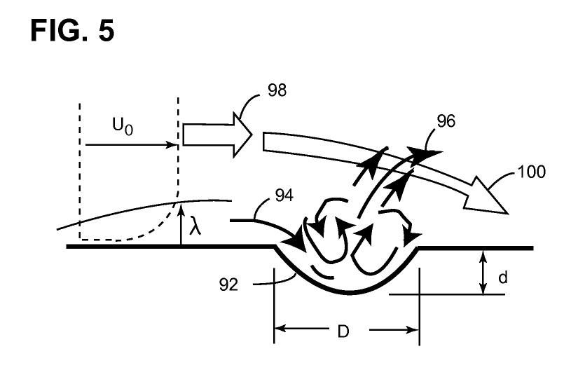

FIG. 5 is a schematic illustration of the concavities in operation. As shown in FIG. 5, portions 94 of fuel flowing in the fuel boundary layer λ along the treated surface are drawn inside each concavity to create vortices that are expelled (as shown by arrow 96) from each concavity 92 toward the free stream flow of air (as shown by arrow 98 representing air flow having a local free stream velocity U₀), thereby locally drawing portions (see arrow 100) of free stream air toward the fuel boundary layer λ. The ratio of a depth “d” relative to a surface diameter “D” of each concavity 92 should be up to about 0.3, and preferably less than about 0.1, to avoid flow separation inside the concavity.

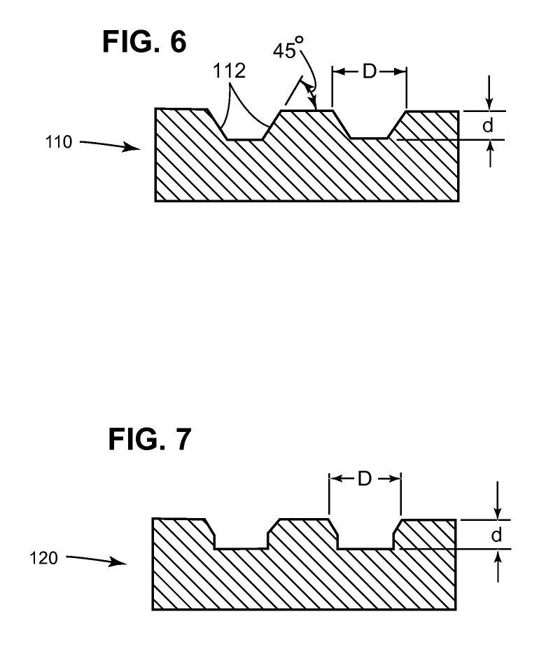

Concavity 92 may be formed, for example, by a hemisphere, or by any portion of a depression surface sector of a full hemisphere. FIGS. 6 and 7 illustrate other exemplary concavity embodiments. The inverted or truncated cone 110 shown in FIG. 6 is a straight-walled geometry approximating a hemisphere. In one embodiment, the surface diameter, D, of the inverted cone is approximately 3 mm, the depth, d, is approximately 0.7 mm, and the side walls 112 make an angle of approximately 45° with the vertical direction. The cone-pit 120 shown in FIG. 7 is a geometry that merges an inverted cone geometry with a cylindrical pit. All of these variations on the hemisphere are manufacturable by various processes in practice, and may have less expensive implementations than the hemisphere. Those of ordinary skill in the applicable arts will understand that the geometrical sizes of the exemplary embodiments presented in FIGS. 6 and 7 are not limiting to those specific dimensions, i.e., a 3-mm diameter concavity is simply an exemplary dimension. Absolute surface diameter and depth will depend on the size of the overall premixer device, as well as the available wall thickness. For example, an not a limitation, if the inlet region of the premixer (near the fuel slots) had a flow diameter of about 25.4 mm, a preferred embodiment for the concavity diameter would be about 2.54 mm with a depth of about 0.51 mm.

In addition, characteristic dimensions of the concavities and their disposition on the surface may be varied according to the desired mixing to be accomplished. For example, and not a limitation, each concavity 92 may have a surface diameter that is constant along the axial direction of the premixing device or of increasing size as the distance from the point of fuel injection increases. In another embodiment, the center-to-center spacing of the arrays of concavities 92 may typically be about 1.1 to about 2 times the surface diameter (D) of the concavities 92, which may be disposed uniformly in the surface of the diffuser 84 with a staggered alignment between respective rows. In other embodiments, the dimensions and spacing of a respective concavity 92 may change in relation to the axial location of the concavity 92 in the diffuser 84 in order to better match the mixing conditions present on the fuel side. This matching effect could also be achieved by variation of the concavity depth or diameter. Typically, each concavity 92 may have a sharp edge at the surface, but smoothed edges may be allowed in a manufacturing process. Additionally, concavities 92 may take on altered geometries, such as those having non-hemispherical and/or have non-axisymmetric shapes (e.g., oval or elliptic surface shapes).

Some of the benefits realized through the use of concavities 92 are increased mixing rates with a great reduction of frictional pressure loses (possibly 50% reduction or more compared to conventional devices). Furthermore, the design of concavities 92 results in a system with less stress intensifiers than current machined turbulators. Additionally, the fuel and oxidizer mixing is more uniformly distributed over the surface of the diffuser 84 through the use of the concavities 92.

In one embodiment of a process to manufacture these concavities 92, a pulse electrochemical machining (PECM) process can be used. This process typically uses a special tooling cathode that consists of a corrosion resistant metal tube (such as a titanium tube) and a patterned electrical insulation coating. Details of such a manufacturing process have been disclosed in U.S. Pat. No. 6,644,921, which is commonly assigned to the assignee of the present invention and the contents of which are hereby incorporated by reference in their entirety.

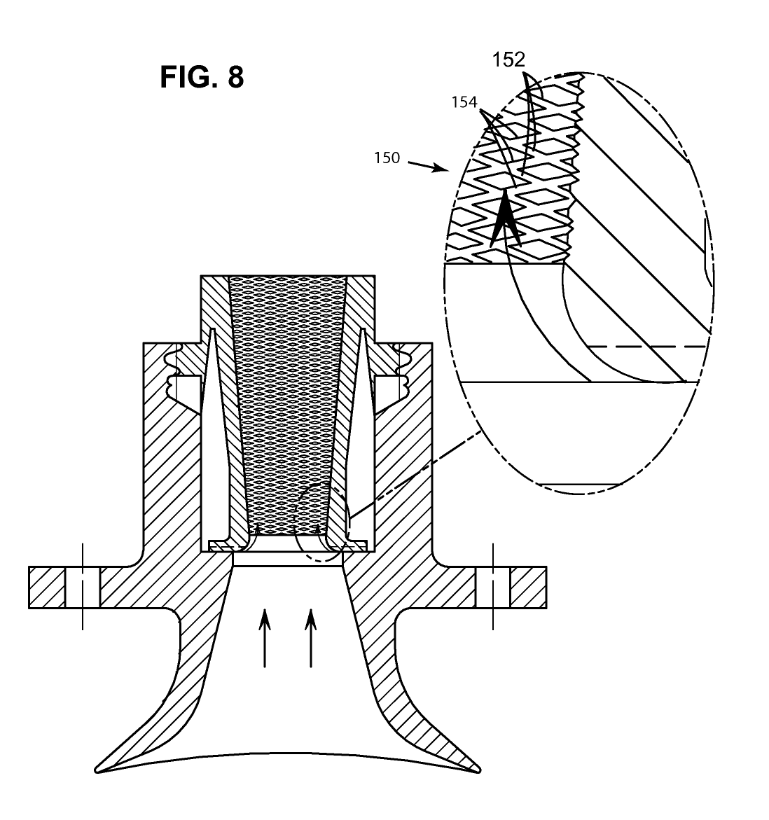

FIG. 8 illustrates another surface treatment embodiment 150 according to the disclosed invention. Those of ordinary skill in the applicable arts will understand that although FIG. 8, and for that matter any of the figures enclosed herein illustrating different exemplary embodiments of the disclosed surface treatments, illustrates the surface treatment embodiment 150 implemented in a premixed device similar to the one illustrated in FIG. 4, all surface treatment disclosed herein are not limited only to that particular premixing device. As shown, this embodiment includes shallow, spherical surface grooves 152, 154 that are crossed, resulting in a diamond patterned surface texture. The annular concave rings or circumferential grooves are spaced axially along the length of the diffuser 84 with the concave surface facing radially outwardly toward the flow. This plurality of similar circumferential grooves angled to the flow direction creates a patterned mixing along the diffuser 84. The shallow grooves provide a function similar to that of the discrete concavities already described. These grooves act to disrupt the flow on the diffuser surface in a manner that enhances mixing, but with a significantly lower pressure loss as compared to conventional devices. Specifically, the fuel flow enters the grooves and forms vortices that then interact with the mainstream flow for mixing enhancement.

The depth of the grooves 152, 154 may be determined based on the dimensions of the diffuser 84 and, similarly to the concavities 92, these grooves may have a relative depth less than about 0.3, and preferably less than about 0.1. As illustrated, first rows of concave, circumferential grooves 152 are formed on the surface of diffuser 84 and are angled (i.e., at an acute angle relative to a center axis of the diffuser) in one direction along the length of the diffuser 84, while similar second rows of grooves 154 are angled in the opposite direction, thus creating a criss-cross pattern to induce additional global effects of mixing enhancement. The criss-crossed grooves 152, 154 may be of uniform cross-section (as shown), or patterned (not shown). In a patterned disposition, the grooves 150 may be formed by circumferentially overlapped, generally circular or oval concavities with the concavities radially facing the fuel flow. Those of ordinary skill in the art will understand that although the exemplary embodiment associated with FIG. 8 uses continuous grooves, discontinuous grooves are also within to scope of the disclosed invention.

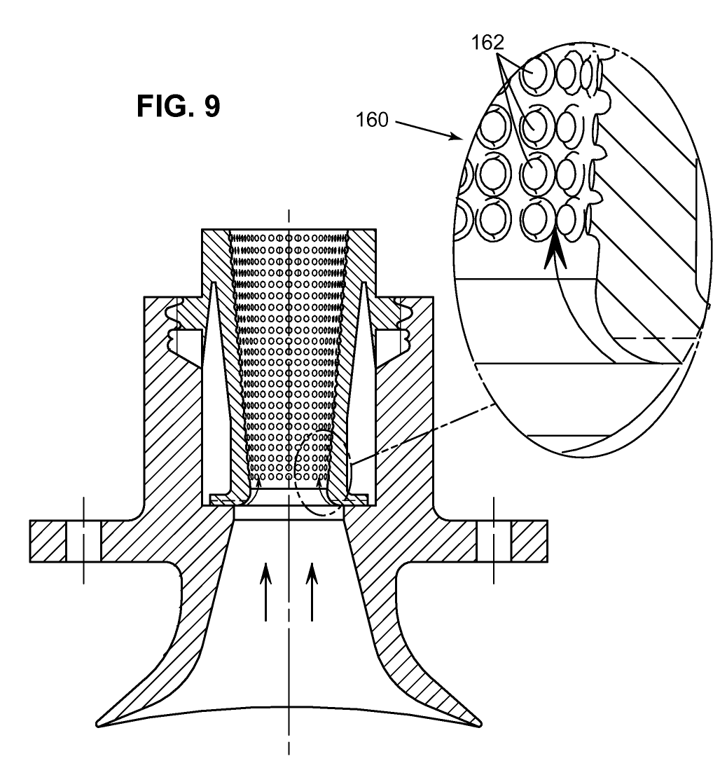

FIG. 9 illustrated yet another surface treatment embodiment 160 that includes short and rounded bumps 162, or moguls, in a patterned array configured to generate flow vortices for mixing. In order to avoid local flow separation, these bumps are made short such that bump height-to-diameter ratio should be around 0.3 or less (basically the inverse of the concavities 92). Variations in this embodiment include, but are not limited to, pin arrays having different heights, diameters, center spacings, pin tip radii, and pin base fillet radii. Short pin arrays are also envisioned with an increased density of pins achieved by decreased pin-to-pin spacing such that adjacent fillets almost touch each other. One of the design features of the embodiment illustrated in FIG. 9 is the fact that the bumps or roughness pieces are small enough to allow the generation of flow turbulence or turbulence augmentation without actual stabilizing a flow separation zone. Flow separation zones can be small and unstable or fluctuating, in which case they will not be able to locally stabilize a flame. In addition, adding fillets and radius to the bumps may also help lessen pressure loss and keep the flow streamlines close to the features, again avoiding stable separations.

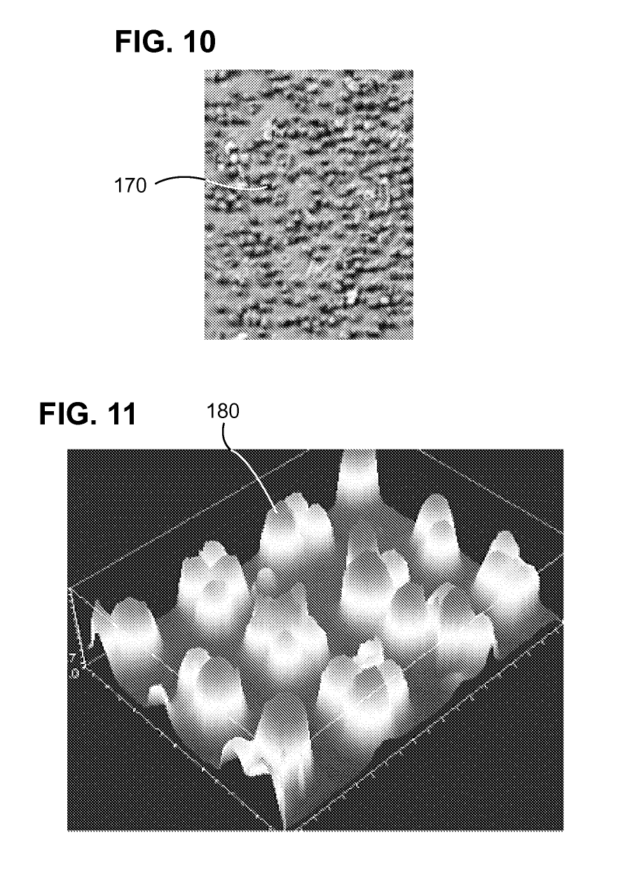

FIGS. 10 and 11 are photographs of other surface treatment embodiments, corresponding to random 170 (FIG. 10) and patterned 180 (FIG. 11) surface roughness of small magnitude applied to the surface of the diffuser 84. One structural feature of these treatments is that enough space is left between roughness elements so as to eliminate bluff body separations. Similar to the formed bumps, surface random roughness 170 and patterned roughness 180 may be applied after nozzle fabrication by brazing. In one embodiment, the surface roughness measured using a profilometer at several locations may have an average roughness value and an average peak-to-peak value Rₐ and R_{z}, ranging from 30 to 50 μm and 180 to 300 μm, respectively. Details on the production of the surface treatments illustrated in FIGS. 10 and 11 are disclosed in U.S. Pat. Nos. 6,526,756 and 6,468,669, the contents of which are incorporated herein by reference in its entirety.

As already noted, the above-described surface treatments may be varied in size and shape as a function of location on the surfaces to allow an adjustment of local conditions as the mainstream flow is accelerated. The surfaces are aerodynamic in that they do not generate significant additional system pressure drop. The surfaces promote the generation of fluid (fuel) vortical mixing structures and wall turbulence, thereby enhancing fuel-air mixing and allowing the overall premixing nozzle to be made more compact. The surface treatments allow for patterning to be altered as a function of fluid travel distance, thereby providing a physical mechanism to vary the effects as the fuel and air mixing progresses downstream. The surfaces do not create flow separations, thus avoiding or minimizing auto-ignition and flame holding inside the diffuser 84. These surfaces could be machined, cast, formed by electro-discharge machining, and in one case applied by brazing.

The premixing devices described above may also be employed in gas-to-liquid system in order to enhance the premixing of oxygen and natural gas prior to reaction in a combustor of the system. Typically, a gas-to-liquid system includes an air separation unit, a gas processing unit and a combustor. In operation, the air separation unit separates oxygen from air and the gas-processing unit prepares natural gas for conversion in the combustor. The oxygen from the air separation unit and the natural gas from the gas-processing unit are directed to the combustor where the natural gas and the oxygen are reacted at an elevated temperature and pressure to produce a synthesis gas. In this embodiment, the premixing device is coupled to the combustor to facilitate the premixing of oxygen and the natural gas prior to reaction in the combustor. Further, at least one surface of the premixing device has a pre-determined profile, wherein the pre-determined profile deflects the oxygen to facilitate attachment of the oxygen to the profile to form a boundary layer, and wherein the boundary layer entrains incoming natural gas to enable the mixing of the natural gas and oxygen at high fuel-to-oxygen equivalence ratios (e.g. about 3.5 up to about 4 and beyond) to maximize syngas production yield while minimizing residence time. In certain embodiment, steam may be added to the oxygen or the fuel to enhance the process efficiency.

The synthesis gas is then quenched and introduced into a Fischer-Tropsh processing unit, where through catalysis, the hydrogen gas and carbon monoxide are recombined into long-chain liquid hydrocarbons. Finally, the liquid hydrocarbons are converted and fractionated into products in a cracking unit. Advantageously, the premixing device based on the Coanda effect generates rapid premixing of the natural gas and oxygen and a substantially short residence time in the gas to liquid system.

The various aspects of the method described hereinabove have utility in different applications such as combustors employed in gas turbines and heating devices, such as furnaces. Furthermore, the technique described here enhances the premixing of fuel and air prior to combustion, thereby substantially reducing emissions and enhancing the efficiency of systems like gas turbines and appliance gas burners. The premixing technique can be employed for different fuels such as, but not limited to, gaseous fossil fuels of high and low volumetric heating values including natural gas, hydrocarbons, carbon monoxide, hydrogen, biogas and syngas. Thus, the premixing device may be employed in fuel flexible combustors for integrated gasification combined cycle (IGCC) for reducing pollutant emissions. In addition, the premixing device may be employed in gas range appliances. In certain embodiments, the premixing device is employed in aircraft engine hydrogen combustors and other gas turbine combustors for aero-derivatives and heavy-duty machines. In particular, the premixing device described may facilitate substantial reduction in emissions for systems that employ fuel types ranging from low British Thermal Unit (BTU) to high hydrogen and pure hydrogen Wobbe indices. Further, the premixing device may be utilized to facilitate partial mixing of streams such as oxy-fuel that will be particularly useful for carbon dioxide free cycles and exhaust gas recirculation.

Thus, the premixing technique based upon the Coanda effect on a premixing device with surface treatments for enhanced mixing described above enables enhanced premixing and flame stabilization in a combustor. Further, the present technique enables reduction of emissions, particularly NOₓ emissions from such combustors, thereby effecting the operation of the gas turbine in an environmentally friendly manner. In certain embodiments, this technique facilitates minimization of pressure drop across the combustors, more particularly in hydrogen combustors. In addition, the enhanced premixing achieved through the Coanda effect on a nozzle with surface treatments for enhanced mixing facilitates enhanced turndown (i.e., the ratio of the a burner's maximum firing capability to the burner's minimum firing capability), flashback resistance, and increased flameout margin for the combustors.

In the illustrated embodiments, the fuel boundary layer is positioned along the walls via the Coanda effect resulting in substantially higher level of fuel concentration at the wall including at the outlet plane of the premixing device. Further, the turndown benefits from the presence of the higher concentration of fuel at the wall, thereby stabilizing the flame and increasing flashback resistance. It should be noted that the flame is kept away from the walls, thus allowing better turndown and permitting operation on natural gas and air mixtures having an equivalence ratio as low as about 0.2. Additionally, the flameout margin is significantly improved as compared to existing systems. Further, as described earlier, this system may be used with a variety of fuels, thus providing enhanced fuel flexibility. For example, the system may employ either natural gas or H₂, for instance, as the fuel. The fuel flexibility of such system eliminates the need of hardware changes or complicated architectures with different fuel ports required for different fuels. As described above, the described premixing devices may be employed with a variety of fuels, thus providing fuel flexibility of the system. Moreover, the technique described above may be employed in the existing can or can-annular combustors to reduce emissions and any dynamic oscillations and modulation within the combustors. Further, the illustrated device may be employed as a pilot in existing combustors.

Methods for premixing a fuel and an oxidizer in a combustion system are also within the scope of the embodiments of the invention disclosed. Such methods including the steps of drawing an oxidizer inside a premixing device, injecting fuel into the premixing device, deflecting the injected fuel towards a wall profile within the premixing device so as to form a fuel boundary layer along an inside wall of the premixing device, and premixing the fuel and oxidizer to form a fuel-air mixture without causing a boundary layer flow separation and a flame holding in the mixing chamber, the premixing step including enhancing an entrainment of the oxidizer into the fuel boundary layer via turbulence generated in the fuel boundary layer by a surface treatment disposed on at least a portion of an inside wall of the premixing device.

With respect to the above description, it should be realized that the optimum dimensional relationships for the parts of the invention, to include variations in size, form function and manner of operation, assembly and use, are deemed readily apparent and obvious to those skilled in the art, and therefore, all relationships equivalent to those illustrated in the drawings and described in the specification are intended to be encompassed only by the scope of appended claims. In addition, while the present invention has been shown in the drawings and fully described above with particularity and detail in connection with what is presently deemed to be practical and several of the exemplary embodiments of the invention, it will be apparent to those of ordinary skill in the art that many modifications thereof may be made without departing from the principles and concepts set forth herein. Hence, the proper scope of the present invention should be determined only by the broadest interpretation of the appended claims so as to encompass all such modifications and equivalents.

What is claimed is:

1. A premixing device, comprising:
an air inlet;
a fuel plenum in flow communication with an end portion of the air inlet, the fuel plenum including at least one fuel inlet slot over a wall profile, the wall profile being configured to form a boundary layer of fuel supplied from the at least one fuel inlet slot along a portion of an inside wall of the premixing device; and
a mixing chamber where compressed air from the air inlet is mixed with fuel from the boundary layer, the mixing chamber being disposed downstream of the air inlet and the at least one fuel inlet slot and including a surface treatment disposed on at least a portion of the inside wall, the surface treatment being configured to aerodynamically enhance a mixing of the fuel from the boundary layer with the compressed air without causing a boundary layer flow separation and a flame holding in the mixing chamber.

2. The premixing device of claim 1, wherein the wall profile is configured to deflect the fuel supplied through the at least one fuel inlet slot towards the wall profile by a Coanda effect.

3. The premixing device of claim 1, wherein the surface treatment comprises an orderly patterned array of shallow concavities.

4. The premixing device of claim 3, wherein the shallow concavities are selected from the group consisting of hemispherical concavities, inverted-cone concavities, cone-pit concavities, and combinations thereof.

5. The premixing device of claim 4, wherein a ratio of a depth to a surface diameter of each shallow concavity is less than about 0.3.

6. The premixing device of claim 5, wherein the ratio is less than about 0.1.

7. The premixing device of claim 3, wherein at least one dimension of the concavities and their disposition on the surface of the inside wall are determined according to a final mixing level at an exit plane of the premixing device.

8. The premixing device of claim 3, wherein a center-to-center spacing of the concavities in the array varies from about 1.1 to about 2 times a surface diameter of the concavities.

9. The premixing device of claim 3, wherein at least one dimension of each concavity and a spacing of rows of concavities change as a function of an axial location along the inside wall.

10. The premixing device of claim 3, wherein the surface treatment comprises first and second rows of shallow crossed spherical surface grooves disposed in a diamond pattern.

11. The premixing device of claim 10, wherein a depth of each row is determined based on a dimension of the inside wall.

12. The premixing device of claim 3, wherein the surface treatment comprises patterned arrays of rounded bumps.

13. The premixing device of claim 12, wherein each bump has a height-to-diameter ratio of about 0.3 or less.

14. The premixing device of claim 12, wherein the bumps are selected from the group consisting of pin arrays of different heights, pin arrays of different diameters, pin arrays of different center-to-center spacings, pin arrays of different pin tip radii, pin arrays of different pin base fillet radii, and combinations thereof.

15. The premixing device of claim 3, wherein the surface treatment comprises a patterned surface roughness.

16. The premixing device of claim 3, wherein the surface treatment comprises a random surface roughness.

17. The premixing device of claim 16, wherein the random surface roughness has an average roughness and an average peak-to-peak roughness ranging from 30 to 50 μm and 180 to 300 μm, respectively.

18. A low-emission combustor comprising the premixing device of claim 1, wherein the fuel comprises natural gas, or high hydrogen gas, or hydrogen, or biogas, or carbon monoxide, or a syngas.

19. The low-emission combustor of claim 18, wherein the fuel comprises pure hydrogen.

20. A low-emission combustor, comprising:
a combustor housing defining a combustion area; and
a premixing device coupled to the combustor, the premixing device comprising,
an air inlet,
a fuel plenum in flow communication with an end portion of the air inlet, the fuel plenum including at least one circumferential fuel inlet slot over a pre-determined wall profile adjacent the fuel plenum, the pre-determined profile being configured to form a boundary layer of fuel supplied from the at least one fuel inlet slot along an inside wall of the premixing device, and
a mixing chamber where compressed air from the air inlet is mixed with fuel from the boundary layer, the mixing chamber being disposed downstream of the air inlet and the at least one fuel inlet slot and including a surface treatment disposed on at least a portion of the inside wall, the surface treatment being configured to aerodynamically enhance a mixing of the fuel from the boundary layer with the compressed air without causing a boundary layer flow separation and a flame holding in the mixing chamber.

21. The combustor of claim 20, further comprising a swirler disposed in a region near the premixing device.

22. The combustor of claim 20, wherein the pre-determined wall profile is configured to deflect the fuel supplied through the slot towards the wall profile by a Coanda effect.

23. A method for premixing a fuel and an oxidizer in a combustion system, comprising:
drawing the oxidizer inside a premixing device through an oxidizer inlet;
injecting the fuel into the premixing device through a circumferential slot;
deflecting the injected fuel towards a pre-determined wall profile within the premixing device to form a fuel boundary layer along an inside wall of the premixing device; and
premixing the fuel and oxidizer to form a fuel-air mixture without causing a boundary layer flow separation and a flame holding in the mixing chamber, wherein the premixing comprises enhancing an entrainment of the oxidizer into the fuel boundary layer via turbulence generated in the fuel boundary layer by a surface treatment disposed on at least a portion of an inside wall of the premixing device.

24. The method of claim 23, wherein the oxidizer comprises air or an oxidizer having a volumetric content of about 10% oxygen.

25. The method of claim 23, wherein the fuel comprises syngas and the oxidizer comprises high purity oxygen for use in oxy-fuel combustors.

26. The method of claim 23, wherein the deflecting further comprises inducing a Coanda effect via the pre-determined wall profile.

27. A gas turbine, comprising:
a compressor;
a combustor in flow communication with the compressor configured to burn a premixed mixture of fuel and air, the combustor including a premixing device disposed upstream of the combustor, the premixing device, comprising
an air inlet,
a fuel plenum in flow communication with an end portion of the air inlet, the fuel plenum including at least one circumferential fuel inlet slot over a pre-determined wall profile adjacent the fuel plenum, the pre-determined profile being configured to form a boundary layer of fuel supplied from the at least one fuel inlet slot along a portion of an inside wall of the premixing device, and
a mixing chamber where compressed air from the air inlet is mixed with fuel from the boundary layer, the mixing chamber being disposed downstream of the air inlet and the circumferential at least one fuel inlet slot and including a surface treatment disposed on at least a portion of the inside wall, the surface treatment being configured to aerodynamically enhance a mixing of the fuel from the boundary layer with the compressed air without causing a boundary layer flow separation and a flame holding in the mixing chamber; and
a turbine located downstream of the combustor and configured to expand the combustor exit gas stream.

28. A gas to liquid system, comprising:
an air separation unit configured to separate oxygen from air;
a gas processing unit for preparing natural gas;
a combustor for reacting oxygen with the natural gas at an elevated temperature and pressure to produce a synthesis gas enriched with carbon monoxide and hydrogen gas;
a premixing device disposed upstream of the combustor to facilitate the premixing of oxygen and the natural gas prior to reaction in the combustor, wherein the premixing device, comprising
an air inlet,
a fuel plenum in flow communication with an end portion of the air inlet, the fuel plenum including at least one circumferential fuel inlet slot over a pre-determined wall profile adjacent the fuel plenum, the pre-determined profile being configured to form a boundary layer of fuel supplied from the at least one fuel inlet slot along a portion of an inside wall of the premixing device, and
a mixing chamber where compressed air from the air inlet is mixed with fuel from the boundary layer, the mixing chamber being disposed downstream of the air inlet and the at least one fuel inlet slot and including a surface treatment disposed on at least a portion of the inside wall, the surface treatment being configured to aerodynamically enhance a mixing of the fuel from the boundary layer with the compressed air without causing a boundary layer flow separation and a flame holding in the mixing chamber; and
a turbo-expander in flow communication with the combustor for extracting work from and for quenching the synthesis gas.
